(19) United States
(12) Patent Application Publication
(10) Pub. No.: US 2009/0182957 A1
(43) Pub. Date: Jul. 16, 2009

(54) DATA STORAGE APPARATUS

(75) Inventor: Mitsuhiko YASHIRO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/350,291

(22) Filed: Jan. 8, 2009

(30) Foreign Application Priority Data
Jan. 16, 2008 (JP) 2008-007222

(51) Int. Cl. G06F 12/02

(52) U.S. Cl. 711/156; 711/170; 711/E12.005

(57) ABSTRACT

A storage apparatus includes: storage modules for storing data, each of the data including meta data for identifying an attribute of the data, each of the storage modules having a characteristic different from one another; a memory for storing information of the characteristic of each of the storage modules; and a controller for controlling the storage modules so as to optimize allocation of the data among the storage modules, including: a receiving module for receiving external information having meta data and condition information, a selecting module for selecting data having meta data corresponding to the meta data included in the external information among data stored in the storage modules, a determining module for determining a storage module having a characteristic optimum for the condition information, and a updating module for updating location of the selected data so as to be stored in the determined storage module.

### CROSS-REFERENCE TO RELATED APPLICATION

This application is based upon and claims the benefit of priority of the prior Japanese Patent Application No. 2008-007222, filed on Jan. 16, 2008, the entire contents of which are incorporated herein by reference.

### FIELD

A certain aspect of the embodiments discussed herein is related to a data storage apparatus.

### BACKGROUND

Processing speed of data has been dramatically increased in step with technological advance of processors such as central processing units (CPUs). To process a vast amount of data, mass storage apparatuses storing a vast amount of data are used.

Such a mass storage apparatus may include a plurality of storage units such as magnetic disks in combination. The mass storage apparatus includes a plurality of storage units positioned at different layers in a layered structure. More specifically, the storage units have different access speeds. A high-speed and small-capacity storage unit and a low-speed and large-capacity storage unit may coexist in a signal mass storage apparatus.

Data used by a processor is likely to be used again by the processor with no much time elapsed. By storing data lately used onto a high-speed and small-capacity storage unit at a high level layer, a processing speed of the processor can be further increased. Data that has not been used for a long period of time is moved to a low-speed and large-capacity storage unit. With a cost increase in the storage apparatus reduced, a generally high-speed and mass storage apparatus is provided as disclosed in Japanese Laid-open Patent Publication No. 1-292452.

### SUMMARY

According to an aspect of the invention, a storage apparatus for storing data includes a plurality of storage modules for storing data, each of the data including meta data for identifying an attribute of the data, each of the storage modules having a characteristic different from one another; a memory for storing information of the characteristic of each of the plurality of storage modules; and a controller for controlling the storage modules so as to optimize allocation of the data among the storage modules, comprising: a receiving module for receiving external information, the external information having meta data and condition information, a selecting module for selecting data having meta data corresponding to the meta data included in the external information among data stored in the storage modules, a determining module for determining, among the storage modules, a storage module having a characteristic optimum for the condition information of the external information, and a updating module for updating location of the selected data so as to be stored in the determined storage module.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating a major portion of a storage apparatus in accordance with a first embodiment of the present invention;

FIG. 2 illustrates a specific example of a meta information table in accordance with the first embodiment of the present invention;

FIG. 3 illustrates a specific example of a storage medium in accordance with the first embodiment of the present invention;

FIG. 4 is a block diagram illustrating an internal structure of a storage layer controller in accordance with the first embodiment of the present invention;

FIG. 5 is a flowchart illustrating a storage layer control process in accordance with the first embodiment of the present invention;

FIGS. 6A and 6B illustrate a specific example of storage layer control in accordance with the first embodiment of the present invention;

FIG. 7 illustrates a specific example of a meta information table in accordance with a second embodiment of the present invention;

FIG. 8 is a block diagram illustrating an internal structure of a storage layer controller in accordance with the second embodiment of the present invention;

FIG. 9 is a flowchart illustrating a storage layer control process in accordance with the second embodiment of the present invention;

FIGS. 10A and 10B illustrate a specific example of storage layer control in accordance with the second embodiment of the present invention;

FIG. 11 is a block diagram illustrating a major portion of a storage apparatus in accordance with a third embodiment of the present invention;

FIG. 12 is a block diagram illustrating an internal structure of a storage layer controller in accordance with the third embodiment of the present invention;

FIG. 13 is a flowchart illustrating a storage layer control process in accordance with the third embodiment of the present invention; and

FIGS. 14A and 14B illustrate a specific example of storage layer control in accordance with the third embodiment of the present invention.

### DESCRIPTION OF EMBODIMENTS

As described previously, mass storage apparatus does not necessarily efficiently and reliably store data. More specifically, mere storage of data having a high frequency of use onto the storage unit at a high level layer with high priority does not guarantee that the data will be used soon. An effort to efficiently store data has been subject to a limitation. Data that has been stored for a relatively long period of time may need no modification but a storage rule and an importance of the data may change later on. The basic principle that the data of high frequency of use is stored at a high level storage unit is not always acceptable.

The main point of the present invention is described as below. Data is stored at any of a plurality of storage media arranged in a layered structure, and meta information of the data is managed. If a change occurs in an external environment related to the meta information, external information indicating the change is acquired, and the data is moved to a storage medium at a layer matching the external environment. The embodiments of the present invention are described in detail with reference to the drawings.

### First Embodiment

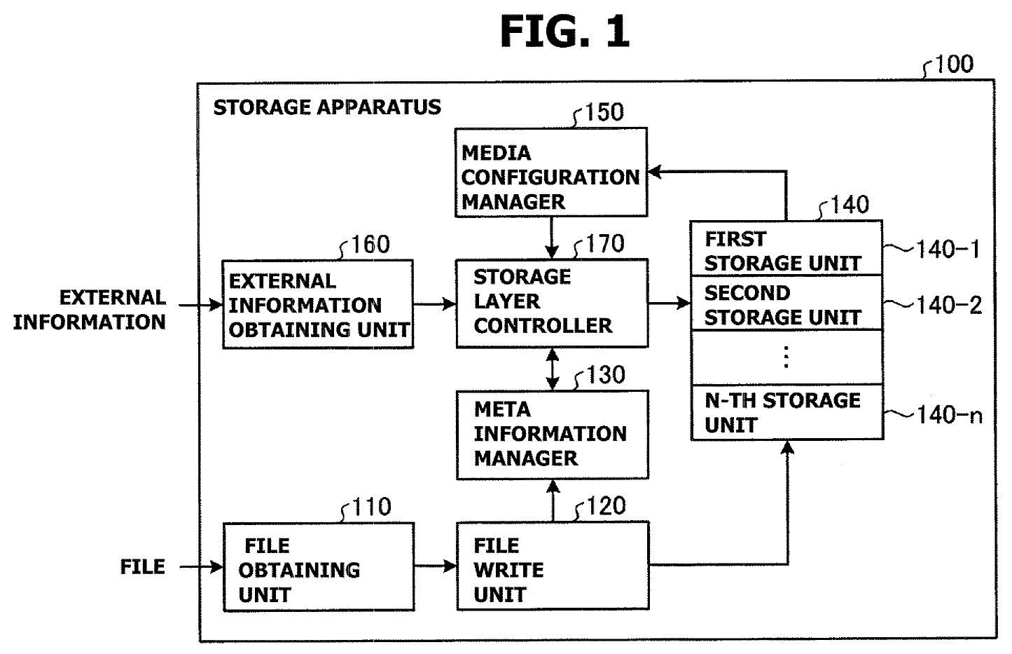

FIG. 1 is a block diagram illustrating a major portion of a storage apparatus 100 in accordance with a first embodiment of the present invention. The storage apparatus 100, for example, includes a plurality of storage modules, a memory and a controller. The plurality of storage modules for storing data. Each of the data includes meta data for identifying an attribute of the data. Each of the storage modules having a characteristic different from one another. The memory stores information of the characteristic of each of the plurality of storage modules. The controller controls the storage modules so as to optimize allocation of the data among the storage modules. The controller includes a receiving module for receiving external information having meta data and condition information, a selecting module for selecting data having meta data corresponding to the meta data included in the external information among data stored in the storage modules, a determining module for determining, among the storage modules, a storage module having a characteristic optimum for the condition information of the external information, and a updating module for updating location of the selected data so as to be stored in the determined storage module. The storage apparatus 100 for storing efficiently and reliably data on a storage medium of an appropriate layer of a layered structure composed of a plurality of storage media. The storage apparatus 100 of FIG. 1 includes a file obtaining unit 110 (the receiving module), a file write unit 120, a meta information manager 130, a storage 140 (the memory), a media configuration manager 150, an external information obtaining unit 160 and a storage layer controller 170 (the selecting module, the determining module and the updating module).

The file obtaining unit 110 obtains data as a storage target from an information processing apparatus (not illustrated) on a per file basis and outputs the obtained file to the file write unit 120.

The file write unit 120 writes the file output from the file obtaining unit 110 onto the storage 140 (storage module) for recording. In this case, the file write unit 120 writes the file onto one of storage units 140-1 through 140-n at an appropriate storage layer within the storage 140 in accordance with meta information representing an attribute and property of the file. The layered structure of the storage 140 will be described later.

The file write unit 120 extracts the meta information from the file and then outputs the meta information to the meta information manager 130. More specifically, the file write unit 120 outputs, as the meta information, the latest update date and the storage limit of the file. The file write unit 120 also outputs to the meta information manager 130 a storage layer as the meta information in the storage 140, in which the file is to be stored.

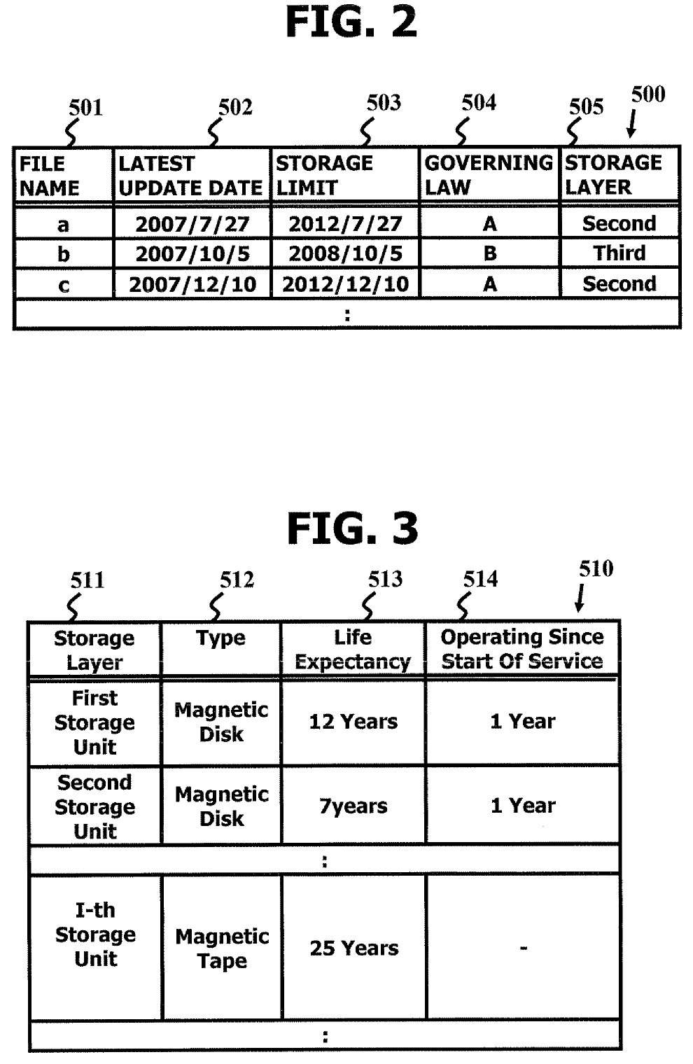

The meta information manager 130 manages the meta information output from the file write unit 120 on a per file basis. More specifically the meta information manager 130 has a meta information management table illustrated in FIG. 2. The meta information management table 500 stores the latest update date 502, the storage limit 503, a governing law 504, and a storage layer 505, each mapped to a file name 501 of the file.

In the meta information management table, the latest update date indicates the data of last updating of the file, and the storage limit indicates a limit until which the file is stored on the storage apparatus 100. The governing law indicates a law that governs the storage limit for each file. For example, as illustrated in FIG. 2, a file “a” and a file “c” are to be stored for five years from the last update date in compliance with a law A, and a file “b” is to be stored for one year from the last update date in compliance with a law B. The storage layer indicates a storage layer of one of the first storage unit 140-1 through the n-th storage unit 140-n in the storage 140 in which a corresponding file is now stored. If the storage layer in the storage 140 having the file stored is changed, the meta information manager 130 updates the storage layer corresponding to the file name of the file in the meta information management table.

The storage 140 includes n different storage media (n being equal to or greater than 2), and stores the file written by the file write unit 120 on one of the storage media. The n storage media of the first storage unit 140-1 through the n-th storage unit 140-n included in the storage 140 form respective storage layers different in characteristics, and store files having meta information corresponding to the storage layers. More specifically, the first storage unit 140-1 may be a magnetic disk having a relatively long life expectancy, the second storage unit 140-2 may be a magnetic disk having a relatively short life expectancy, and the third storage unit 140-3 may be a magnetic tape having a very long life expectancy. In such a case, the storage 140 is layered from the standpoint of life expectancy characteristics. The storage 140 stores a file at a storage layer satisfying a storage limit as one piece of meta information.

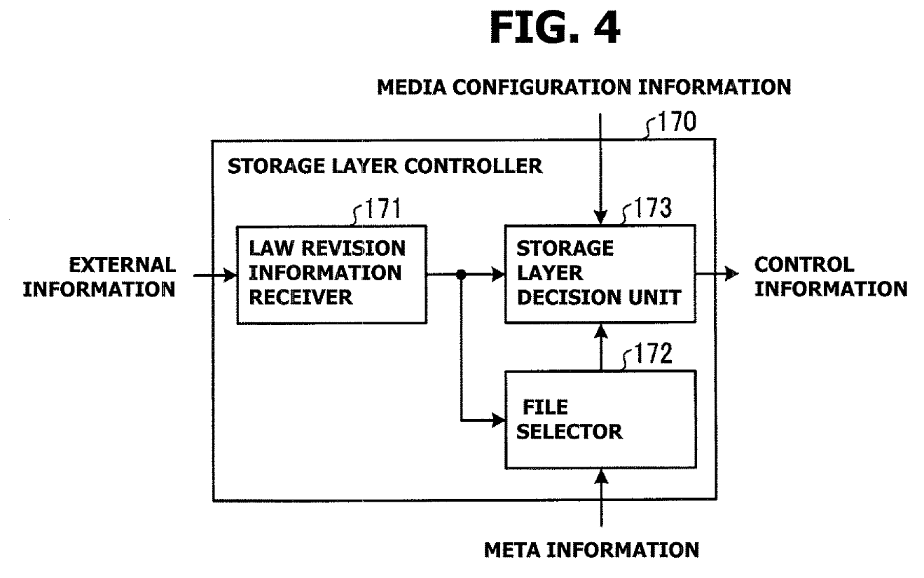

The media configuration manager 150 manages the configuration of the storage media in the storage 140. More specifically, the media configuration manager 150 stores in a table form of FIG. 3 the type and characteristics related to the storage layers of the first storage unit 140-1 through the n-th storage unit 140-n in the storage 140. FIG. 3 illustrates a specific example of a storage medium in accordance with the first embodiment. Storage layer 511 indicates the storage unit. Type 512 indicates type of the storage unit. Life expectancy 513 indicates the life expectancy of the storage unit. Operating since start of service 514 indicates the period of operating since the start of service. In the example of FIG. 3, the first storage unit 140-1 and the second storage unit 140-2 are magnetic disks, and has already been operating for one year since the start of service. The life expectancy of the first storage unit 140-1 is 12 years and the life expectancy of the second storage unit 140-2 is 7 years. The i-th storage unit 140-i is a magnetic tape having a life expectancy of 25 years. The media configuration manager 150 manages, on a per storage layer basis, media configuration information such as the types and characteristics of the above-described storage media. The media configuration manager 150 may also store a variety of characteristics such as an access speed, memory capacity, etc. of each storage medium.

The external information obtaining unit 160 obtains external information indicating a change in an external environment related to the meta information of the file. More specifically, if the meta information of FIG. 2 is stored on the meta information manager 130, the external information obtaining unit 160 obtains, as the external information, information such as a revision to the law stored as a governing law. If a file related to an individual is stored on the storage 140 with a personal attribute managed as the meta information, the external information obtaining unit 160 obtains, as the external information, a change in the personal attribute of the individual unrelated to the file content. In other words, the external information obtaining unit 160 obtains loosely related external information, for example, external information not directly related to a frequency of use of the file stored on the storage 140.

The storage layer controller 170 determines the storage layer of the file stored on the storage 140, based on the meta information managed by the meta information manager 130, the media configuration information managed by the media configuration manager 150, and the external information obtained by the external information obtaining unit 160. The storage layer controller 170 changes the storage layer of the file within the storage 140 by outputting to the storage 140 control information for moving the file to the determined storage layer.

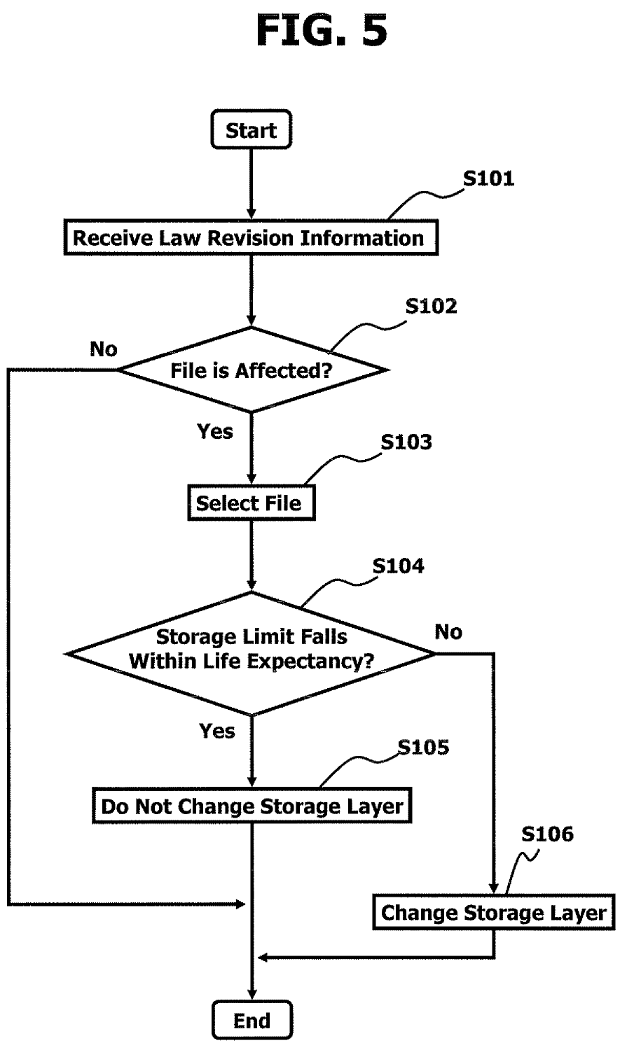

More specifically, the storage layer controller 170 of the first embodiment of the present invention includes a law revision information receiver 171, a file selector 172 and a storage layer decision unit 173, as illustrated FIG. 4.

The law revision information receiver 171 receives, out of the external information obtained by the external information obtaining unit 160, law revision information indicating that a law revision related to an item stored as the meta information has been made. More specifically, if the governing law has been revised to extend the storage limit of the file from five years to ten years, the law revision information receiver 171 receives the law revision information containing the law revision to that effect. The law revision information receiver 171 outputs the law revision information to each of the file selector 172 and the storage layer decision unit 173.

The file selector 172 references the meta information managed by the meta information manager 130, and selects a file subject to the law revision indicated by the law revision information received by the law revision information receiver 171. More specifically, if a law controlling the storage limit of each file is revised, the file selector 172 references the meta information and then selects a file governed by the revised law. For example, the meta information table of FIG. 2 is stored on the meta information manager 130, and the law A is revised The file selector 172 selects the file “a” and the file “c,” governed by the law A. The file selector 172 then notifies the storage layer decision unit 173 of the meta information of the selected file.

The storage layer decision unit 173 decides the storage layer appropriate for the file selected by the file selector 172, based on the law revision information, the meta information, and the media configuration information. More specifically, if the law revision information indicates that the governing law has revised so that the storage limit of the file is extended, the storage layer decision unit 173 selects from the media configuration information the storage layer that allows the life expectancy to cover the extended storage limit and determines the selected storage layer as the storage layer of the file selected by the file selector 172. More specifically, the media configuration of FIG. 3 is managed by the medium configuration manager 150, and if the storage limit of the file stored on the second storage unit 140-2 is extended from five years to ten years, the storage layer decision unit 173 determines as the storage layer of the file the first storage unit 140-1 having ten years or more as a life expectancy.

The storage layer decision unit 173 outputs to the storage 140 control information for moving the file to the determined storage layer, and moves to the storage layer having an appropriate life expectancy the file having the storage limit extended by the law revision. At the same time, the storage layer decision unit 173 updates the storage layer stored as the meta information of the file on the meta information management table of the meta information manager 130.

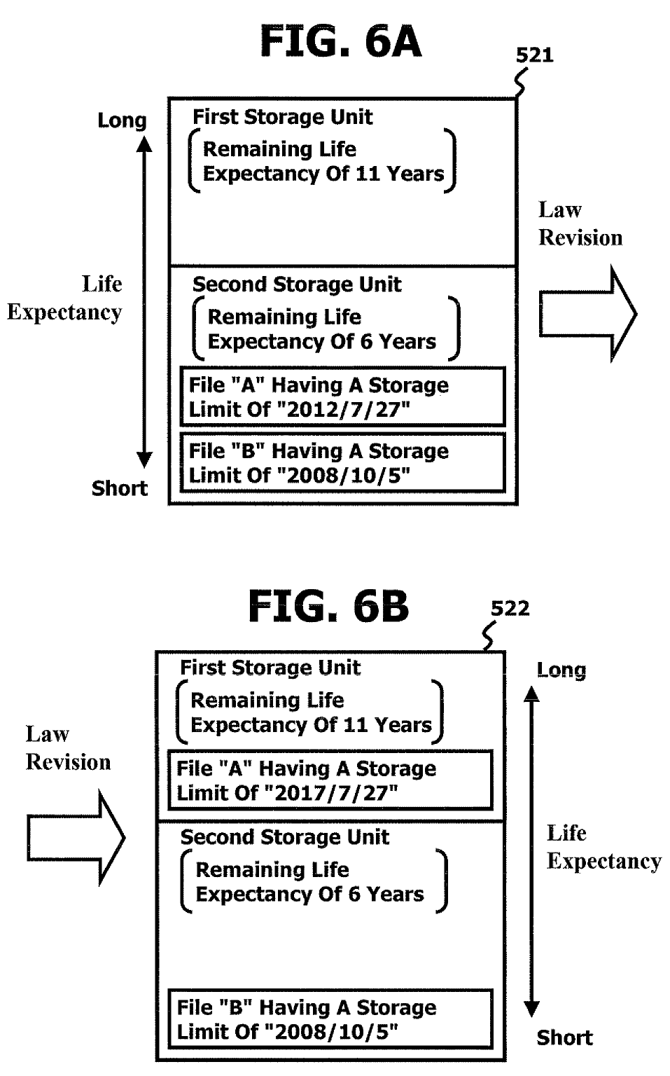

The storage layer control process of the storage layer controller 170 thus configured is described with reference to a flowchart of FIG. 5.

The law revision information receiver 171 receives the law revision information related to the law revision out of the external information obtained by the external information obtaining unit 160 (step S101). The law revision information indicates that the governing law providing a legal basis for the meta information of the file is revised and that the storage limit of the file is modified.

The law revision information is output to the file selector 172, and the file selector 172 determines whether the file affected by the content indicated by the law revision information is stored on the storage 140 (step S102). More specifically, the file selector 172 references the meta information table stored on the meta information manager 130 and determines whether the file governed by the revised law is stored on the storage 140.

If it is determined in step S102 that the file governed by the revised law is not stored, it is not necessary to change the storage layer of the files stored on the storage 140. Processing thus ends. If it is determined in step S102 that the file governed by the revised law is stored, the file selector 172 selects from the meta information management table the file governed by the revised law (step S103).

The meta information of the selected file is transferred from the file selector 172 to the storage layer decision unit 173. The storage layer decision unit 173 determines whether the storage limit of each file falls within the remaining life expectancy indicated by the media configuration information (step 5104). The storage layer decision unit 173 calculates the remaining life expectancy of the storage layer by subtracting the elapsed year from the life expectancy indicated by the media configuration information of the storage layer storing the current file. The storage layer decision unit 173 thus determines whether or not the storage limit of the file modified by the law revision is beyond the remaining life expectancy of the storage layer.

If it is determined in step S104 that the storage limit of the file modified by the law revision is not beyond the remaining life expectancy of the storage layer, the current storage layer remains good even if the file is affected by the law revision. The storage layer decision unit 173 does not change the storage layer having the current file stored thereon (step S105). On the other hand, if it is determined in step 5104 that the storage limit of the file modified by the law revision is beyond the remaining life expectancy of the storage layer, the life expectancy of the storage medium expires before it reaches the storage limit of the file with the file remaining at the current storage layer. The storage layer decision unit 173 outputs to the storage 140 the control information for moving the file to another storage layer to change the storage layer of the file (step S106). In this case, the storage layer decision unit 173 references the media configuration information, thereby selecting the storage layer having the remaining life expectancy exceeding the storage limit of the file subsequent to the law revision. The storage layer decision unit 173 thus decides to move the file to the selected storage layer.

The file having the storage limit extended by the law revision is moved to the storage layer usable even later than the extended storage limit. The storage apparatus 100 can thus store reliably the file until the storage limit required by the law. Here, the file is moved to the high level storage layer having a longer remaining life expectancy when the storage limit of the file is extended by the law revision. The storage layer decision unit 173 can move the file to a low-level storage layer having a shorter remaining life expectancy if the storage limit of the file is shortened by a law revision. In this way, all the files affected by the law revision are stored at appropriate storage layers. The storage limit of each file is observed while cost reductions are achieved by minimizing an amount of files to be stored on a costly storage medium having a long life expectancy.

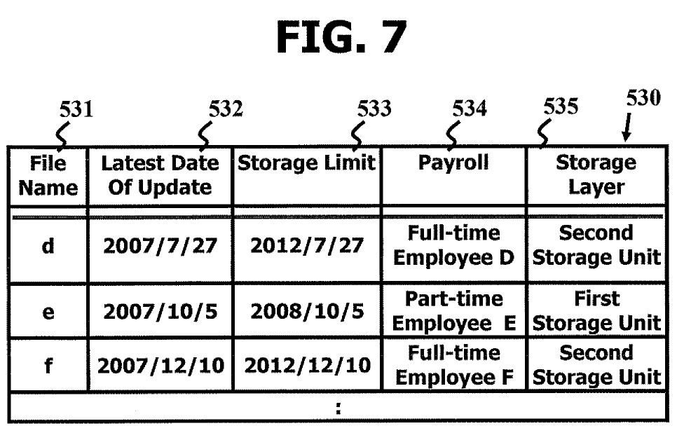

A specific example of the storage layer control of the first embodiment of the present invention is described with reference to FIG. 6A and FIG. 6B. FIG. 6A illustrates a state 521 of the storage layer before control. FIG. 6B illustrates a state 522 of the storage layer after control. In accordance with the first embodiment of the present invention, the media of the first storage unit 140-1 through the n-th storage unit 140-n in the storage 140 are layered according to the standpoint of life expectancy. As illustrated in FIG. 6A, the first storage unit 140-1 has the longest life expectancy.

As illustrated in FIG. 6A, the file “a” having a storage limit of “2012/7/27” and the file “b” having a storage limit of “2008/10/5” are stored on the second storage unit 140-2 having a remaining life expectancy of six years prior to a law revision. Let “2007/12/10” be the present day, and each of the file “a” and the file “b” will reach the storage limit thereof before the life expectancy of the second storage unit 140-2 expires six years later. Prior to the law revision, the second storage unit 140-2 is an appropriate storage layer for the file “a” and the file “b.”

A law controlling the storage limit of the file “a” may be revised, and the storage limit of the file “a” may be extended to “2017/7/27.” The extended storage limit becomes later than the expiration of the life expectancy of the second storage unit 140-2, and a reliable storage of the file “a” is not guaranteed In accordance with the first embodiment, the external information obtaining unit 160 obtains the external information including the law revision information, and the law revision information receiver 171 receives the law revision information. Since the law revision information indicates that the law revision has extended the storage limit, the file selector 172 selects from the meta information management table the file subject to the revised law. The file selector 172 thus selects the file “a.”

The storage layer decision unit 173 determines that the extended storage limit of the file “a” causes the life expectancy of the second storage unit 140-2 as the current storage layer to be insufficient. The storage layer decision unit 173 thus decides that the storage layer of the file “a” be changed to a higher level first storage unit 140-1 having a longer life expectancy. As illustrated in FIG. 6B, the file “a” is moved to the first storage unit 140-1. Since the first storage unit 140-1 has a remaining life expectancy of eleven years, the storage medium thereof is usable until the storage limit of the file “a” and the file “a” is thus reliably stored.

In accordance with the first embodiment, the meta information of the data is used to select the data corresponding to the external information related to the meta information and the selected data is moved to a storage medium having different characteristics. For example, if already stored data changes in importance as an external environment changes, the data may be moved to a storage medium having characteristics matching the new importance With the layered structure applied to a plurality of storage media, the data is stored efficiently and reliably onto an appropriate recording medium.

For example, if the storage limit of the data changes in response to a change in the external environment such as a revision to related laws, the data can be moved to a storage medium having a life expectancy matching the changed storage limit. The data is thus reliably stored on the storage medium.

The law revision information related to the meta information of the file (data) is obtained. The file affected by the law revision indicated by the obtained law revision information is selected from the meta information. If the storage layer currently storing the selected file fails to satisfy the storage condition subsequent to the law revision, the selected file is then moved to the storage layer satisfying the storage condition. For example, even if the law revision has extended the storage limit of the file, the file is moved to the storage layer that remains usable until the storage limit. The file is thus reliably stored. In other words, when a plurality of storage media are arranged in a layered structure, data is efficiently and reliably stored onto a storage medium at an appropriate layer.

### Second Embodiment

A feature of the second embodiment of the present invention is that a file is moved to a low level storage layer having a low access speed or deleted if the importance of the file is lowered by a change in an external environment.

The major portion of the storage apparatus of a second embodiment of the present invention is identical to the storage apparatus 100 of the first embodiment (FIG. 1), and the discussion thereof is omitted. The second embodiment of the present invention is different from the first embodiment in the meta information managed by the meta information manager 130 and the internal structure of the storage layer controller 170.

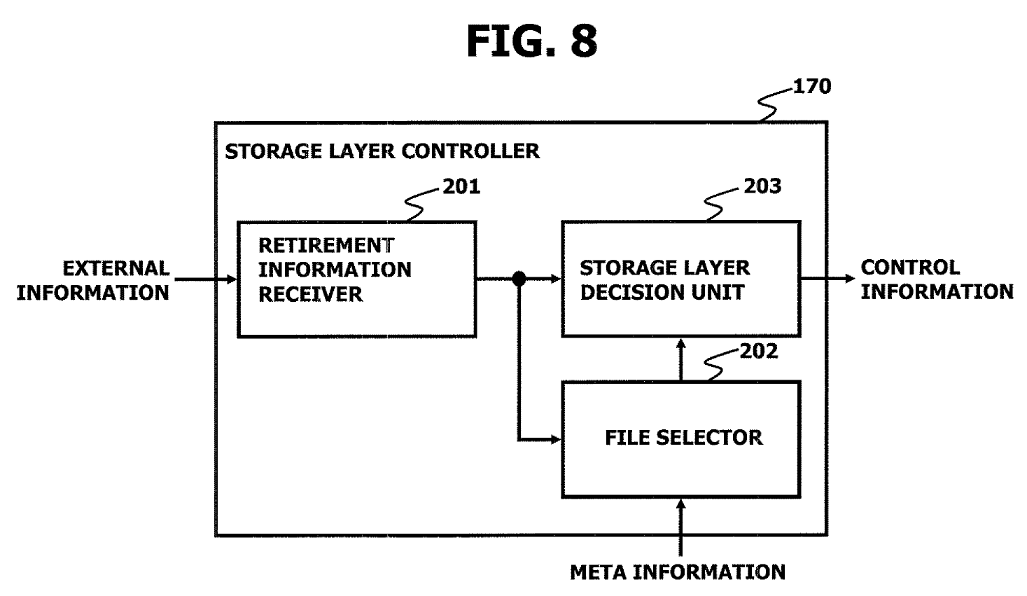

The meta information manager 130 of the second embodiment of the present invention stores a meta information management table illustrated in FIG. 7. The meta information management table lists the latest date of update 532, a storage limit 533, a payroll 534, and a storage layer 535, each mapped to the file name 531 of a respective file. In accordance with the second embodiment of the present invention, the file to be stored on the storage 140 includes information relating to each employee of a company, and information regarding an employee name indicating which file is related to which individual is managed as the meta information as illustrated in FIG. 7. The information regarding each employee name includes a type indicating whether the employee is a full-time employee or a part-time employee. As illustrated in FIG. 7, a file “d” and a file “f” related to full-time employees are stored on the second storage unit 140-2 and a file “e” related to a part-time employee is stored on the first storage unit 140-1.

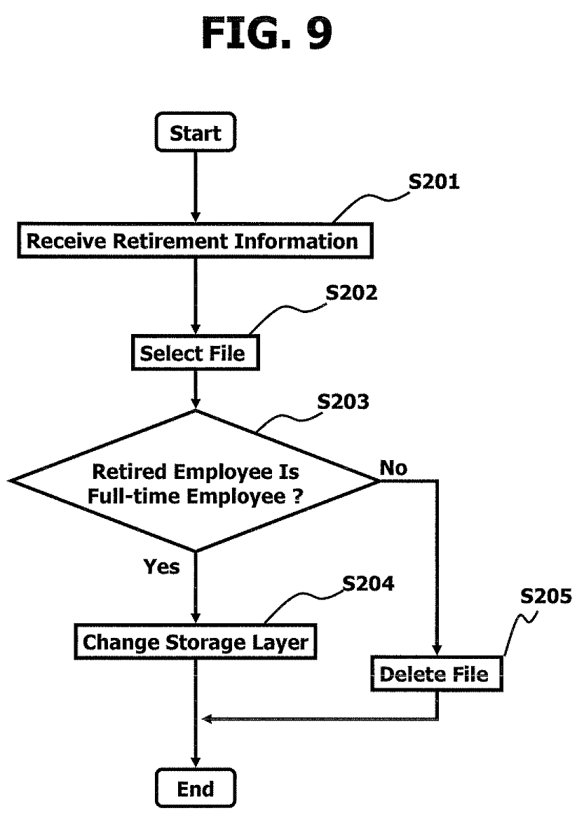

The storage layer controller 170 of the second embodiment includes a retirement information receiver 201, a file selector 202 and a storage layer decision unit 203 as illustrated in FIG. 8.

Out of the external information obtained by the external information obtaining unit 160, the retirement information receiver 201 receives, as the meta information, retirement information indicating that an employee whose name is stored has retired. More specifically, if an employee whose file is stored on the storage 140 has retired, the retirement information receiver 201 receives the retirement information indicating the retirement of that employee. The retirement information receiver 201 outputs the retirement information to each of the file selector 202 and the storage layer decision unit 203.

The file selector 202 references the meta information managed by the meta information manager 130, and selects the file of the employee corresponding to the retirement information received by the retirement information receiver 201. More specifically, if the meta information management table of FIG. 7 is stored on the meta information manager 130 and the retirement information receiver 201 has received the retirement information indicating that an employee D has retired, the file selector 202 references the meta information and selects the file “d” storing the employee D as the employee name. The file selector 202 notifies the storage layer decision unit 203 of the meta information of the selected file.

The storage layer decision unit 203 determines the storage layer appropriate for the storage of the file selected by the file selector 202, based on the retirement information, the meta information, and the media configuration information. More specifically, the storage layer decision unit 203 references the meta information of the retired employee, thereby determining whether the retired employee is a full-time employee or a part-time employee. If the retired employee is a full-time employee, the storage layer decision unit 203 selects from the media configuration information a storage layer having a relatively low access speed and a large storage capacity, and then determines the storage layer as a storage layer for the file corresponding to the retired employee. If the retired employee is a part-time employee, the storage layer decision unit 203 decides to delete the file corresponding to the retired part-time employee. More specifically, the storage layer decision unit 203 detects a change in the importance of from file to file in response to the retirement information and discriminates the importance of the file based on the meta information of the file of the employee corresponding to the retirement information. Depending on the importance of each file, the storage layer decision unit 203 determines an appropriate storage layer or whether to delete the file.

The storage layer decision unit 203 outputs to the storage 140 control information for moving the file to the determined storage layer or control information for deleting the file. The storage layer decision unit 203 thus moves the file related to the refired employee to a storage layer of the importance of the file or deletes the file. Concurrently, the storage layer decision unit 203 updates the storage layer stored as the meta information of the file or deletes the meta information in the meta information management table on the meta information manager 130.

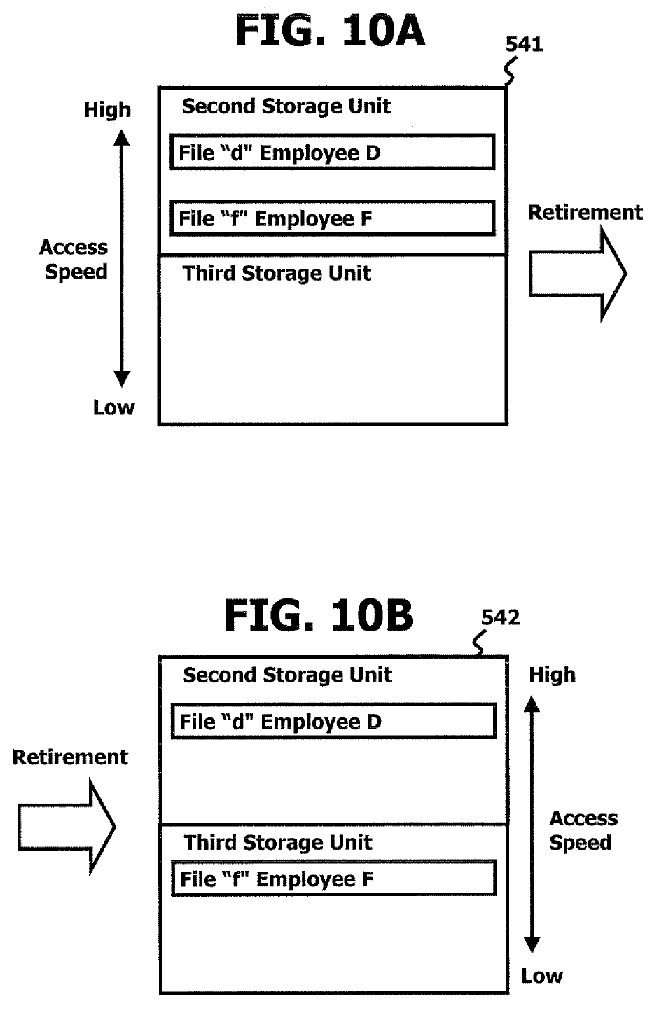

The storage layer control process of the storage layer controller 170 thus constructed is described below with reference to a flowchart of FIG. 9.

The retirement information receiver 201 receives the retirement information related to a retired employee out of the external information obtained by the external information obtaining unit 160 (step S201). The retirement information indicates that an employee having an employee name as one piece of the external information of the file has retired and that the importance of the file related to that employee has changed.

The retirement information is output to the file selector 202. The file selector 202 references the meta information table stored on the meta information manager 130, thereby selecting the file corresponding to the employee indicated by the retirement information (step S202). The meta information of the selected file is transferred from the file selector 202 to the storage layer decision unit 203. The storage layer decision unit 203 determines based on the meta information of the file whether or not the retired employee is a full-time employee (step S203). More specifically, the storage layer decision unit 203 references the employee name of the meta information to determine whether the retired employee is a full-time employee or a part-time employee.

If it is determined in step S203 that the retired employee is a full-time employee, the storage layer decision unit 203 outputs to the storage 140 control information for moving the file from the current storage layer to a storage layer having a low access speed and a large storage capacity because the importance of the file of the employee drops. The storage layer decision unit 203 thus changes storage layers (step S204). If it is determined in step S203 that the retired employee is a part-time employee, the storage layer decision unit 203 outputs to the storage 140 control information for deleting the file because the importance of the file of the part-time employee drops. The storage layer decision unit 203 thus deletes the file (step S205).

When an employee retires, the frequency of accesses to his or her file is considered to drop. The file is then moved to a storage layer having a low access speed and a large storage capacity or is deleted. The storage capacity of an expensive storage layer having a high access speed is saved, leading to a cost reduction. The handling of the file is determined depending on whether the retired employee is a full-time employee or a part-time employee. The handling of the file may be determined by another piece of information stored as the meta information of each file. The file of the retired employee may be modified in storage layer regardless of the meta information.

For example, the decision means may compares the storage limit of the data contained in the meta information with the usable period of each of the first storage means and the second storage means, thereby deciding whether to move the data from the first storage means to the second storage means.

With this arrangement, the data is moved to the storage medium being usable at least until the storage limit of the data. The data can thus be stored reliably until the storage limit.

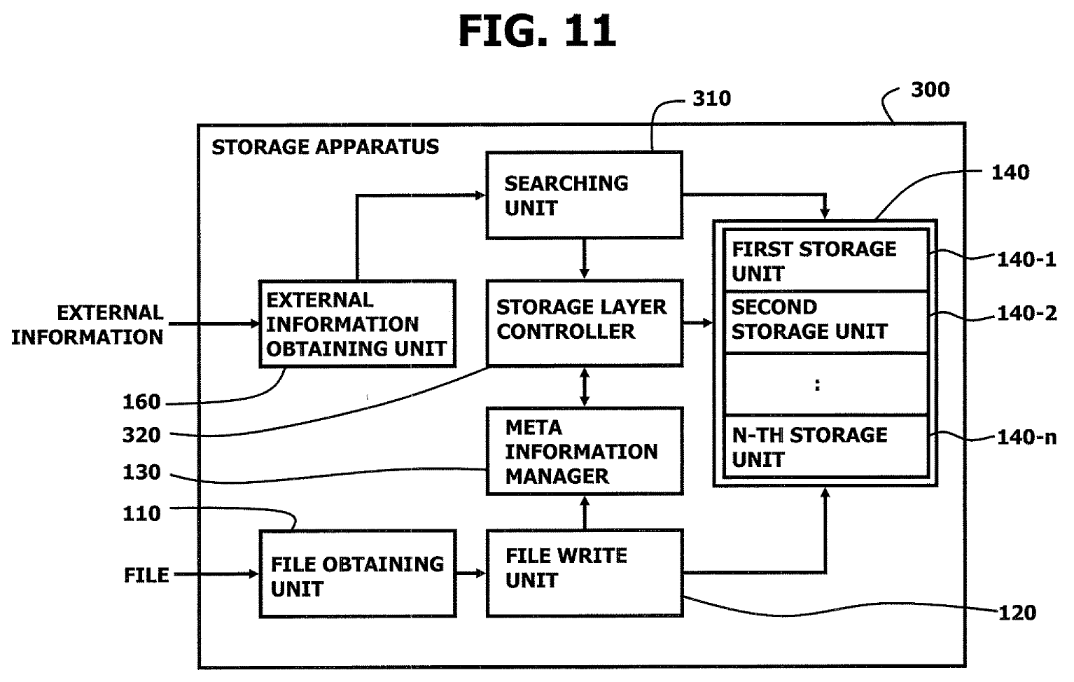

The storage layer control process of the second embodiment of the present invention is described below with reference to FIG. 10A and FIG. 10B. FIG. 10A illustrates a state 541 of the storage layer before control. FIG. 10B illustrates a state 542 of the storage layer after control. In accordance with the second embodiment, the storage media of the first storage unit 140-1 through the n-th storage unit 140-n within the storage 140 are layered from the standpoint of access speed. As illustrated in FIG. 10, the second storage unit 140-2 is higher in access speed than the third storage unit 140-3.

As illustrated in FIG. 10A, a file “d” of an employee D and a file “f” of an employee F are stored on the second storage unit 140-2 prior to the retirement of the employee F. In accordance with the second embodiment, efficiency of process, such as updating of the files, is improved by storing the file “d” and the file “f” of the employees D and F on the second storage unit 140-2 having a relatively high access speed prior to retirement. In other words, the second storage unit 140-2 is considered a storage layer appropriate for storing the file “d” and the file “f” prior to retirement.

If the employee F retires, the frequency of accesses to the file “f” drops. The file “f”, if remaining there, continuously occupies the second storage unit 140-2 having a relatively high access speed. In accordance with the second embodiment, the external information obtaining unit 160 obtains the external information containing the retirement information and the retirement information receiver 201 receives the external information. Since the retirement information indicates that the employee F has retired, the file selector 202 selects the file of the employee F from the meta information table. The file selector 202 selects the file “f” in this case.

The storage layer decision unit 203 determines based on the meta information whether the file “f” is a file of a full-time employee or a part-time employee. Since the file “f” is a file of a full-time employee, the storage layer decision unit 203 decides to move the file “f” to the third storage unit 140-3 having a relatively lower access speed. As illustrated in FIG. 10B, the file “f” is moved to the third storage unit 140-3. The access speed of the third storage unit 140-3 is relatively low. Even if a size of data stored on the third storage unit 140-3 increases as a result of an increase in the number of files, a cost increase is still controlled. Since the employee F has retired, few accesses to the file “f” takes place. No problems arise even if the file “f” is stored on the third storage unit 140-3 having a relatively low access speed.

If the file selected from the retirement information is a file of a part-time employee, the file of that part-time employee is no longer needed after retirement. The storage layer decision unit 203 deletes the file of the part-time employee without changing storage layers.

In accordance with the second embodiment of the present invention, the retirement information related to the meta information of the file is obtained, and the file corresponding to the obtained retirement information is selected from the meta information. The selected file, which could otherwise occupy part of a storage capacity of the high level storage layer, is moved to a lower level storage layer or deleted. If an access frequency to the file of an employee drops subsequent to the retirement of the employee, part of the storage capacity of an expensive storage medium having a relatively high access speed is not continuously occupied after the retirement. The file is stored on a storage medium at an appropriate level.

### Third Embodiment

A third embodiment of the present invention is described below. If search criteria are specified to a stored file as a change in an external environment, the file can satisfy the search criteria on the basis of the meta information only. The extracted file is then moved to a high level storage layer having a higher access speed.

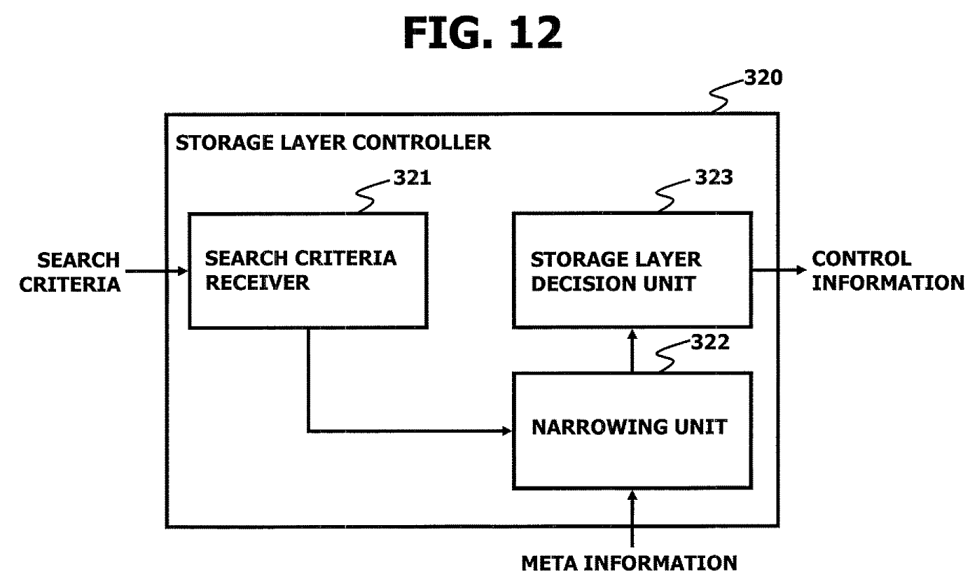

FIG. 11 is a block diagram illustrating a major portion of a storage apparatus 300 in accordance with the third embodiment of the present invention. In FIG. 11, elements identical to those illustrated in FIG. 1 are designated with the same reference numerals and the discussion thereof is omitted herein. The storage apparatus 300 of FIG. 11 includes a searching unit 310 and a storage layer controller 320 in addition to the file obtaining unit 110, the file write unit 120, the meta information manager 130, the storage 140, and the external information obtaining unit 160.

The searching unit 310 obtains search criteria for use in searching a file, out of the external information obtained by the external information obtaining unit 160. The searching unit 310 then extracts a file matching the search criteria from the files stored on the storage 140. The searching unit 310 searches the files stored on the storage layer having the highest access speed, thereby extracting a file matching the search criteria. The searching unit 310 then outputs the extracted file to an information processing apparatus (not illustrated) that has specified the search criteria. Prior to an actual search operation, the searching unit 310 outputs to the storage layer controller 320 the search criteria for use in searching the file.

The storage layer controller 320 determines a storage layer of the file stored on the storage 140, based on the meta information managed by the meta information manager 130 and the search criteria used by the searching unit 310 in the search operation. The storage layer controller 320 outputs to the storage 140 control information for moving the file to the determined storage layer, thereby changing storage layers for the file within the storage 140.

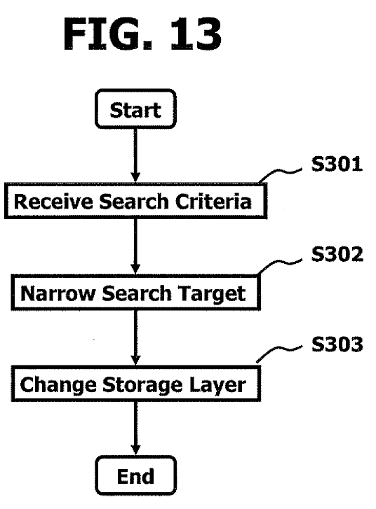

More specifically, the storage layer controller 320 of the third embodiment of the present invention includes a search criteria receiver 321, a narrowing unit 322 and a storage layer decision unit 323, as illustrated in FIG. 12.

The search criteria receiver 321 receives the search criteria used by the searching unit 310 in file searching. More specifically, the search criteria receiver 321 receives the search criteria such as the date of file updating and a keyword. The search criteria receiver 321 outputs the search criteria to the narrowing unit 322.

The narrowing unit 322 references the meta information managed by the meta information manager 130, and selects a file matching the search criteria received by the search criteria receiver 321. More specifically, if each file stored on the storage 140 is a file of transmission mail, the date of transmission of the mail may be contained in the search criteria. The narrowing unit 322 may then narrow the files as a search target according to the date of transmission serving as one piece of the meta information. The searching unit 310 performs full file searching. Instead of referencing the meta information and performing a full search process, the narrowing unit 322 narrows the range of search by excluding files that falls out of the search target according to the search criteria. The narrowing unit 322 notifies the storage layer decision unit 323 of the file obtained as a search target as a result of search narrowing.

The storage layer decision unit 323 decides to move the search target file obtained by the narrowing unit 322 to a storage layer having the highest access speed, outputs to the storage 140 control signal to that effect, and then moves the search target file to the storage layer. More specifically, the storage layer decision unit 323 achieves a high-speed search process by moving in advance the search target file of the searching unit 310 to the storage layer having the high access speed.

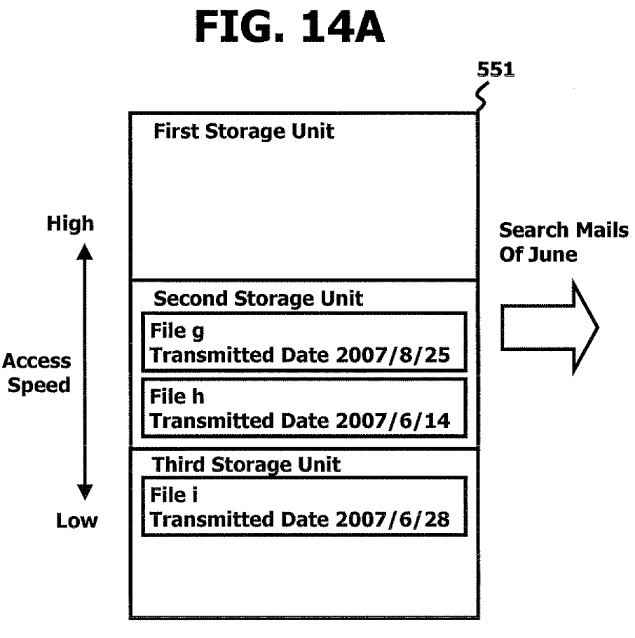

A storage layer control process of the storage layer controller 320 thus constructed is described below with reference to a flowchart of FIG. 13.

The search criteria receiver 321 receives the search criteria to be used by the searching unit 310 in searching (step S301). The search criteria contain a condition related to the meta information of the file. In other words, if the latest update date of the file is managed as the meta information, a condition identifying the latest update time and date is contained in the search criteria.

The search criteria are output to the narrowing unit 322. The narrowing unit 322 narrows the search target in the selection of files having the meta information that matches part of the search criteria (step S302). In other words, the narrowing unit 322 references the meta information, thereby narrowing the search target by excluding files unlikely to match the search criteria.

In the search target narrowing process, the narrowing unit 322 may predict search criteria to be specified next, based on a history of the search criteria recently specified, and then exclude files in accordance with the predicted search criteria. For example, a history of search criteria recently specified is for searching for mails transmitted in consecutive months, such as “mails transmitted in June” and “mails transmitted in July,” next search criteria are predicted to be “mails transmitted in August.” Before the search criteria receiver 321 receives the search criteria, the search target narrowing process may be performed based on the meta information to set “mails transmitted in August” as the search target.

The search target file is then transferred to the storage layer decision unit 323. The storage layer decision unit 323 outputs to the storage 140 control information for moving all the search target files to one of the storage layers and then changes storage layers of the files (step S303). More specifically, by outputting the control signal for moving the search target files to the highest level storage layer having the highest access speed, the storage layer decision unit 323 collects all the search target files at the highest level storage layer.

When the searching unit 310 searches for files matching the search criteria, all the files matching the search criteria are already collected at the highest level storage layer. The searching unit 310 simply searches only the storage layer having a high access speed, thereby achieving a high-speed search process. When the narrowing unit 322 predicts the search criteria as previously discussed, files can be collected at the storage layer having a higher access speed at an earlier phase of the process. Even higher speed file search process is performed.

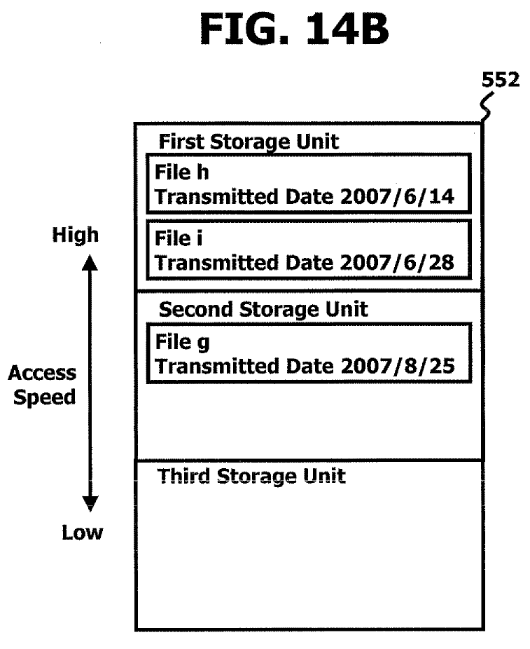

A specific example of the storage layer control of the third embodiment of the present invention is described below with reference to FIG. 14A and FIG. 14B. FIG. 14A illustrates a state 551 of the storage layer before control. FIG. 14B illustrates a state 552 of the storage layer after control. In accordance with the third embodiment, the storage media of the first storage unit 140-1 through the n-th storage unit 140-n are layered from the standpoint of access speed. As illustrated in FIG. 14A and FIG. 14B, the first storage unit 140-1 has the highest access speed.

As illustrated in FIG. 14A and FIG. 14B, before the start of a search by the searching unit 310, the second storage unit 140-2 stores a file “g” of a transmitted mail dated “2007/8/25” and a file “h” of a transmitted mail dated “2007/6/14” and the third storage unit 140-3 stores a file “i” of a transmitted mail dated “2007/6/28.” The current storage layer of each file is determined taking into consideration the importance of the file.

The searching unit 310 has now obtained the search criteria for searching mails containing a particular keyword from among the “mails transmitted in June.” The search criteria, received by the search criteria receiver 321, is output to the narrowing unit 322. The narrowing unit 322 references the meta information of each file, and narrows the search target files to the “mails transmitted in June” according to the date of transmission stored as one piece of meta information. The narrowing unit 322 excludes the file “g” as a file target, and sets the file “h” and the file “i” as a file target.

The storage layer decision unit 323 decides to change the file “h” and the file “i” from the storage layers thereof to the first storage unit 140-1 having the highest access speed. As illustrated in FIG. 14A and FIG. 14B, the file “h” and the file “i” are moved to the first storage unit 140-1. The first storage unit 140-1 is higher in access speed than each of the second storage unit 140-2 and the third storage unit 140-3. In a search process according to the above search criteria, the searching unit 310 accesses each file at a high speed and searches for a mail containing a particular keyword.

In accordance with the third embodiment of the present invention, the search criteria related to the meta information of the files are obtained, the search target is narrowed in accordance with the obtained search criteria and the meta information of the files, and the search target files obtained through the search target narrowing process are collected at the storage layer having a high access speed. In the actual search process, only the files stored on the storage layer having a high access speed are simply searched. A high-speed search process is thus performed.

In each of the above-described embodiments, the meta information manager 130 manages the meta information of the files. The present invention is also applicable to the case in which each file has the meta information thereof. More specifically, when the meta information of the file is needed, one of the storage layer controller 170 and the storage layer controller 320 references the file stored on the storage 140 in order to obtain the meta information.

In each of the above-described embodiments, the first storage unit 140-1 through the n-th storage unit 140-n have respectively storage medium thereof. The present invention is not limited to this arrangement. More specifically, the first storage unit 140-1 through the n-th storage unit 140-n may include disk devices of different level respectively, each including redundant arrays of independent disks (RAID). In this case, the external information related to the meta information of each file is determined by importance of the file. The more important file is stored on a storage layer having a higher level RAID structure.

A high level storage layer may include a plurality of storage media. Important files may be stored on the plurality of storage media at the high level storage layer with redundancy. In such a case, the high level storage layer may be composed of a plurality of storage media different in type, such as a magnetic disk fixed to the storage apparatus 100 and a magnetic tape as a removable medium. With this arrangement, the files stored on the high level storage layer are stored on the magnetic disk in order to guarantee a predetermined value of access speed or higher while also being stored on the magnetic tape in order to assure long life expectancy.

In accordance with each of the above-described embodiments, the storage 140 and other processing units may be arranged in separate housings. More specifically, the files stored on the storage 140 composed of a plurality of storage media may be moved to one of the storage layer controller 170 and the storage layer controller 320 arranged in an external device. Instead of arranging all the first storage unit 140-1 through the n-th storage unit 140-n within the storage 140 separate from another controller, some storage units only may be arranged in the other controller.

In accordance with the third embodiment, the searching unit 310 is included in the storage apparatus 300. Alternatively, the searching unit 310 may be arranged external to the storage apparatus 300. In such a case, the external information obtaining unit 160 may obtain as the external information the search criteria to be used by the searching unit 310 in the search process.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A storage apparatus for storing data, comprising:
a plurality of storage modules for storing data, each of the data including meta data for identifying an attribute of the data, each of the storage modules having a characteristic different from one another;
a memory for storing information of the characteristic of each of the plurality of storage modules; and
a controller for controlling the storage modules so as to optimize allocation of the data among the storage modules, comprising:
a receiving module for receiving external information, the external information having meta data and condition information,
a selecting module for selecting data having meta data corresponding to the meta data included in the external information among data stored in the storage modules,
a determining module for determining, among the storage modules, a storage module having a characteristic optimum for the condition information of the external information, and
an updating module for updating location of the selected data so as to be stored in the determined storage module.

2. The storage apparatus according to claim 1, wherein the memory further includes usable period information of each of the plurality of the storage modules, the meta data further includes a period information for storing the data, the receiving module further receives the external information including the information indicating a period information of the data is to be modified, the selecting module further selects data having the period information from the plurality of storage modules in accordance with the external information, and a updating module further updates the selected data to the storage module having a longer usable period than the period information of the selected data.

3. The storage apparatus according to claim 1, wherein the external information further includes accessing information that indicates the meta data to be accessed lower, the selecting module further selects data from the plurality of storage modules in accordance with the external information, and a updating module updates the selected data to the storage module having the response time corresponding to the accessing information.

4. The storage apparatus according to claim 1, wherein the external information further includes search criteria according to which desired data is searched, the selecting module further selects data serving as a search target of the search criteria included in the external information from the plurality of the storage modules, and a updating module updates the data selected by the selecting module to the storage module having a higher access speed than the storage module storing the data.

5. The storage apparatus according to claim 1, wherein the receiving module receives the external information indicating a change in the importance of the data, the determining module determines to move the data selected by the selecting means to the storage means having a lower access speed than the storage means storing the data.

6. A method for controlling a storage apparatus including a plurality of storage modules for storing data, each of the data including meta data for identifying an attribute of the data, each of the storage modules having a characteristic different from one another, a memory for storing information of the characteristic of each of the plurality of storage modules, the method comprising:
receiving external information, the external information having meta data and condition information;
selecting data having meta data corresponding to the meta data included in the external information among data stored in the storage modules;
determining, among the storage modules, a storage module having a characteristic optimum for the condition information of the external information; and
updating location of the selected data so as to be stored in the determined storage module;

7. The method according to claim 6, wherein the memory includes usable period information of each of the plurality of the storage modules, the meta data includes a period information for storing the data, the receiving step further receives the external information including the information indicating a period information of the data is to be modified, the selecting step further selects data having the period information from the plurality of storage modules in accordance with the external information, and the updating step further updates the selected data to the storage module having a longer usable period than the period information of the selected data.

8. The method according to claim 6, wherein the external information further includes accessing information that indicates the meta data to be accessed lower, the selecting further selects data from the plurality of storage modules in accordance with the external information, and the updating step further updates the selected data to the storage module having the response time corresponding to the accessing information.

9. The method according to claim 6, wherein the external information further includes search criteria according to which desired data is searched, the selecting step further selects data serving as a search target of the search criteria included in the external information from the plurality of the storage modules, and the updating step further updates the data selected by the selecting step to the storage module having a higher access speed than the storage module storing the data.

10. The method according to claim 6, wherein the receiving receives the external information indicating a change in the importance of the data, the determining determines to move the data selected by the selecting means to the storage means having a lower access speed than the storage means storing the data.
